(19) United States
(12) Patent Application Publication
(10) Pub. No.: US 2005/0002108 A1
(43) Pub. Date: Jan. 6, 2005

(54) Optical stack of laminated removable lenses

(76) Inventors: Bart Wilson, San Juan Capistrano, CA (US); Seth Wilson, San Juan Capistrano, CA (US); Stephen S. Wilson, Sun Juan Capistrano, CA (US)

Correspondence Address: STETINA BRUNDA GARRED & BRUCKER, 75 ENTERPRISE, SUITE 250, ALISO VIEJO, CA, 92656, US

(21) Appl. No.: 10/901,946

(22) Filed: Jul. 29, 2004

Related U.S. Application Data
(63) Continuation of application No. 10/178,140, filed on Jun. 24, 2002, now abandoned.
Application No. 10/178,140 is a continuation-in-part of application No. 10/050,366, filed on Jan. 16, 2002, now abandoned.
Application No. 10/050,366 is a continuation of application No. 09/449,318, filed on Nov. 24, 1999, now Pat. No. 6,388,813.

(51) Int. Cl. G02B 27/14

(52) U.S. Cl. 359/630

(57) ABSTRACT

A stack of laminated removable transparent lenses which consists of two alternating optically clear materials in intimate contact. The materials are a plastic lens and a clear adhesive. The adhesive is uninterrupted. The lens and the adhesive have a refraction mismatch of less than 0.2. The lens stack can be used as a graffiti stop. The lenses are resistant to scratching.

### CROSS-REFERENCE TO RELATED APPLICATIONS

This application is a continuation-in-part of U.S. application Ser. No. 10/050,366 filed Jan. 16, 2002, the entire contents of which are incorporated by reference herein, which is a continuation of U.S. application Ser. No. 09/449,318 filed Nov. 24, 1999, now U.S. Pat. No. 6,388,813, the entire contents of which are incorporated by reference herein.

### STATEMENT RE: FEDERALLY SPONSORED RESEARCH/DEVELOPMENT

(Not Applicable)

### BACKGROUND OF THE INVENTION

The present application relates generally to guards and protectors, and more particularly, to a stack of removable lenses that can be adhered to a surface and removed one at a time when a new/clean surface is desired.

Face shields are employed in environments where contamination of the eyes may occur. It is well known in the art that flexible, transparent lenses affixed by numerous methods are overlaid on the face shield for protection. The lenses are easily removed and discarded when visibility is reduced from the accumulation of dirt or other contaminants. In motor sports, for instance, multiple layers of transparent lenses are overlaid on the face shield, each being sequentially removed as they become contaminated, because they reduce the visibility of the operator. The drawback of the lenses in the prior art is that each transparent lens applied over the face shield is itself a hindrance to good visibility due to its optical index of refraction. Most common plastic materials have optical indexes of refraction ranging from 1.47 to 1.498. The index mismatch between the removable lens and air (air has an optical index of 1.00) causes a reflection of 4% of the light that would normally come to the operator's eyes. This reflection effect is additive for each additional surface-to-air interface. Thus, for each removable lens having two surfaces, the reflections are 8%. A stack of seven lenses would reflect 42% of the light away from the operator thereby reducing the brightness of the objects viewed. A second optical phenomenon occurs simultaneously that also reduces visibility. The reflections are bi-directional and thus make the lens stack appear as a semi-permeable mirror to the operator. This mirror effect further reduces visibility because the light that passes through the lens stack reflects off of the operator's face and then reflects off of the lens stack into the operator's eyes. The effect to the operator is that he sees his own image on the inside of the stack nearly as brightly as the objects viewed on the outside. This significantly reduces visibility.

Another drawback to this stacking arrangement is that moisture exhaled by the operator's breath can cloud or fog up the lenses, also reducing visibility. The air space between each lens allows the moisture to enter this area.

The requirement of being able to see through a face shield is similar to that of being able to see through a vehicle window. The accumulation of dirt or other contaminants impairs the wearer's visibility through a face shield. In the case of a vehicle, dirt and other contaminants can be washed off. However, graffiti, whether applied (e.g., with paint) or scratched (e.g., with a carbide tip or etched with acid) can cause costly damage to vehicles, such as busses. This problem extends to the entire vehicle, not just the windshield or other windows. In the case of the windshield or mirrors, not only can the damage be costly, but it can impair the driver's visibility.

The examples discussed all share the common problem of having a surface that needs to be protected. A need exists for protecting such surfaces and for restoring them to a clean state.

### BRIEF SUMMARY OF THE INVENTION

An aspect of the present invention provides a series of easily removable optically clear lens stacks that do not cause reflection to the operator's eyes. The prior art discloses reflective lens stacks that do cause reflections to the operator's eyes. An example of this type of prior art of reflective lens stacks is disclosed in U.S. Pat. No. 5,592,698 issued on Jan. 14, 1997 to Woods.

Refraction is the change in the direction in which waves travel when they pass from one kind of matter into another. Waves are refracted (bent) when they pass at an angle from one medium into another in which the velocity of light is different. The amount that a ray of a certain wavelength bends in passing from one medium to another is indicated by the index of refraction between the two mediums for that wavelength. The index of refraction indicates the amount that a light ray bends as it passes out of one substance and into another. When light passes from air to a denser substance, such as Mylar film, it slows down. If the light ray enters the Mylar film at any angle except a right angle, the slowing down causes the light ray to bend or refract at the point of entry. The ratio of the speed of light in air to its speed in the Mylar film is the Mylar film's index of refraction.

The present invention includes a series of alternating optically clear films whose indexes of refraction are matched to within 0.2 and which will nearly eliminate all reflections to the operator's eyes. The layers of film are adhesively laminated to one another and are compliant so there is no air between the layers. The film layers can be large and generally rectangular in shape and may include a tab extending from each of the film layers. The tabs can be staggered so that the user can remove the top most layer and then the next layer. This embodiment of the present invention can be applied to race car windshields, windows, visors or direct view displays such as ATM machines that are subject to contaminating environments. Accordingly, the present invention is an adhesively laminated multi-layered clear film adapted to be used on a racer's face shield, or on the windshield of a race car to keep the viewing area clean during the course of a race.

Other embodiments of the present invention may be used on a surface as a graffiti stop. The surface may be a vehicle, such as a bus. The lens stack may be applied to the vehicle body and/or to the vehicle windows, including the windshield. Embodiments of the invention used as graffiti stops should not have tabs, as the stack of lenses should not be self-evident. A removable tab can be affixed to the top layer of the lens stack for removing the top layer of film. Such shields should be resistant to scratching and etching, such as acid etching.

Other embodiments may include use of the stack of lenses on the display of a computing device, such as a hand held computing device.

Yet other embodiments may include use of the stack of lenses on a grocery display, such as a produce display.

The stack of lenses may be tinted. Such tinting is accomplished by tinting the bottom lens of the stack of lenses. The stack of lenses may also have a total or partial mirror effect. Such a mirror effect is achieved via a mineralized deposition on the bottom layer of film in the stack of lenses.

### BRIEF DESCRIPTION OF THE DRAWINGS

An illustrative and presently preferred embodiment of the present invention is shown in the accompanying drawings, in which:

FIG. 1 is a perspective view of an off-road wearer's helmet showing one embodiment of the present invention affixed to the face shield of the helmet;

FIG. 2 is a front elevational view of the helmet shown in FIG. 1 showing the tab portion without any adhesive for allowing the wearer of the helmet to easily grasp the tab and peel off the soiled top layer of the present invention;

FIG. 3 is a partial sectional view taken along line 3-3 in FIG. 2 showing the tension post extending outwardly from the face shield with the left-side and tab portion of the present invention;

FIG. 4 is a front elevational view illustrating the present invention before it is affixed to the face shield of the helmet;

FIG. 5 is a top view of the stackable lenses illustrating seven layers of lens held together by an adhesive applied between each lens with the thicknesses of the layers of each lens and applied adhesive highly exaggerated to clearly show the relationship between the lenses and the adhesive and also to show the end portions that do not have any adhesive between each lens layer for forming the removable tab portions at both ends of the present invention;

FIG. 6 illustrates a 60″ wide roll of film, which will be used to cut out the optical stacks that are illustrated in FIG. 4. The gray stripes illustrate the clear adhesive, and the clear stripes illustrate the clear film without adhesive. It is to be understood that the gray stripes are for illustration purposes only, because the adhesive is clear;

FIG. 7 is an exploded perspective view illustrating seven sheets of film layer and seven layers of clear adhesive interposed between each sheet of film layer for use in embodiments where the film layers are mounted by wetting the last (bottom) adhesive layer directly to a windshield, a window, or the like;

FIG. 8 is a view of the laminated sheets illustrated in FIG. 7 having a rectangular shape with a series of six tabs for removing each top layer of the lenses successively as the uppermost exposed lens layer becomes soiled or otherwise contaminated;

FIG. 9 illustrates a bus having the sheets of film layer and adhesive shown in FIG. 7 attached thereto;

FIG. 9A illustrates a cross section of the sheets of film layer and adhesive affixed to the bus as shown in FIG. 9;

FIGS. 9B and 9C illustrate the sheets of film layer and adhesive shown in FIG. 9A with a tab used for removing the top sheet of film layer;

FIG. 9D illustrate a tab used for removal of the top sheet of film layer shown in FIGS. 9B-9C;

FIG. 10 illustrates a produce display case having the sheets of film layer and adhesive shown in FIG. 7 attached thereto; and

FIG. 11 illustrates a hand-held computing device having the sheets of film layer and adhesive shown in FIG. 7 attached thereto.

### DETAILED DESCRIPTION OF THE INVENTION

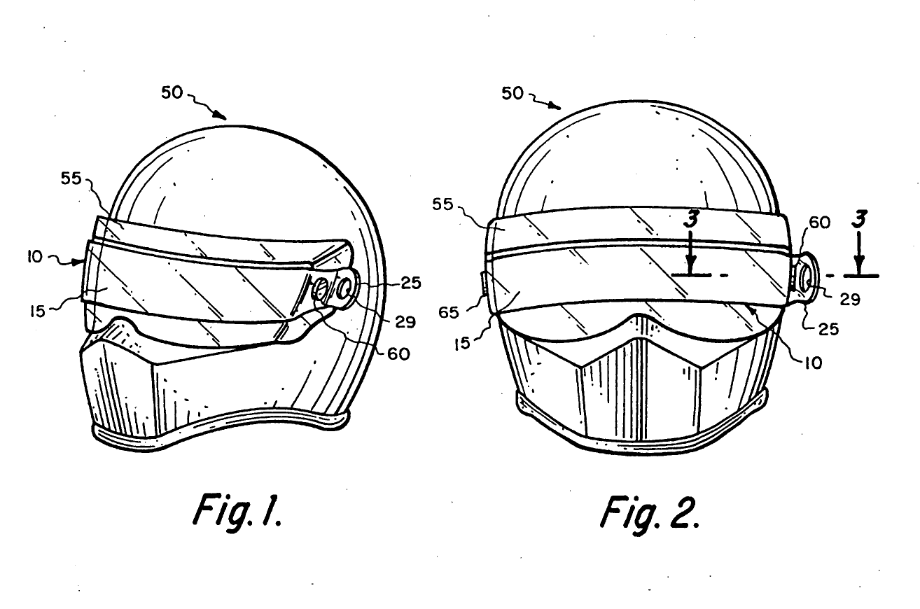

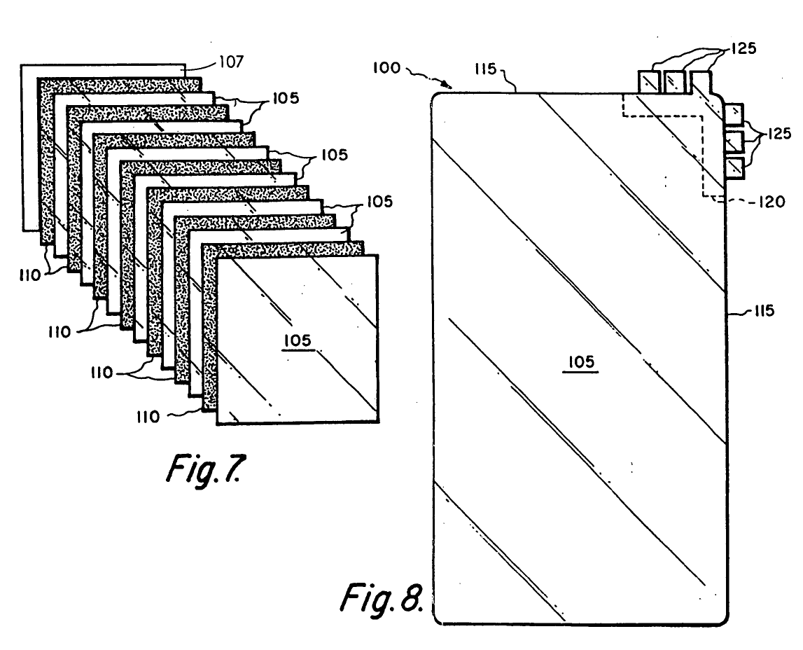

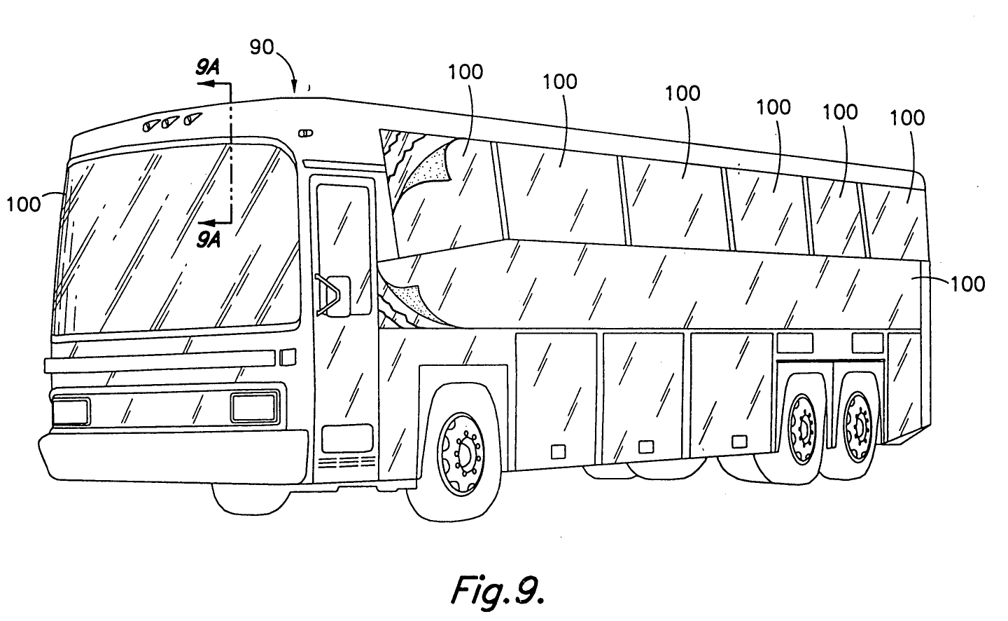

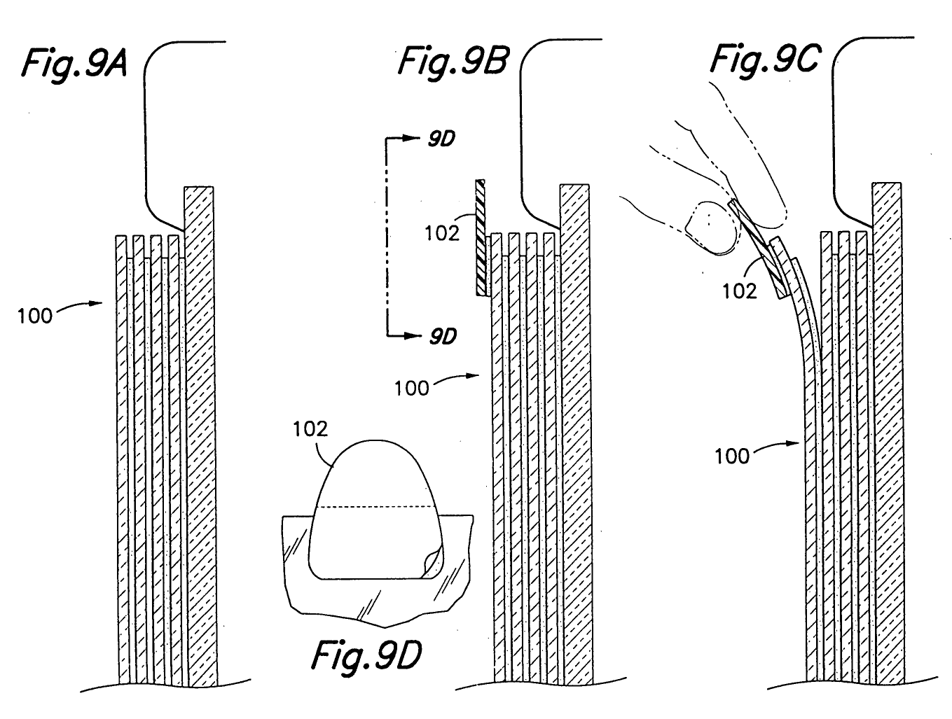

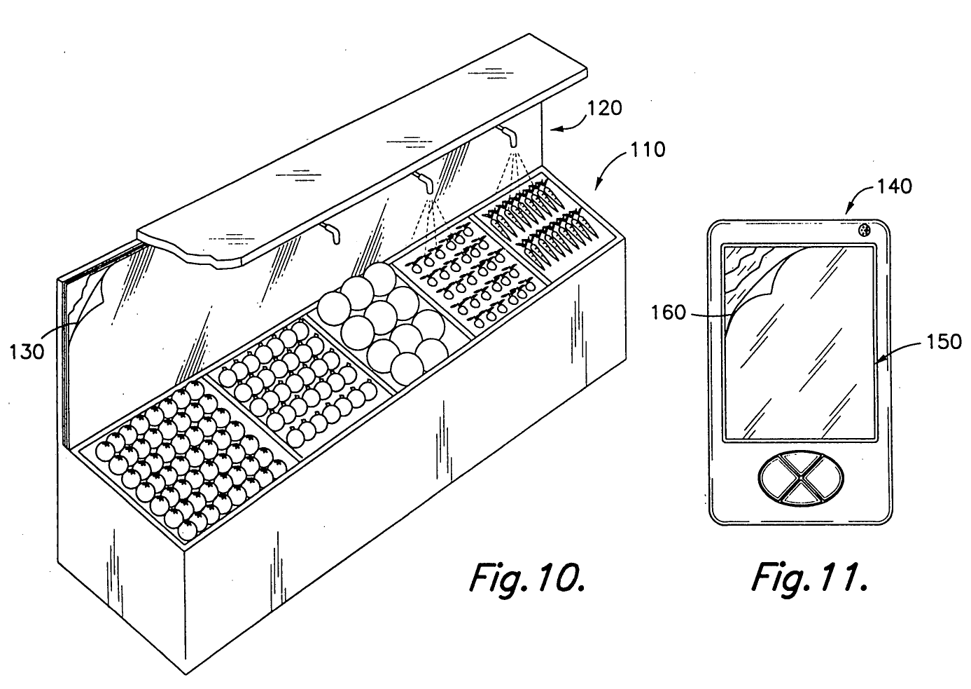

Referring now to the drawings wherein the showings are for purposes of illustrating preferred embodiments of the present invention only, and not for purposes of limiting the same, several embodiments are illustrated. A first embodiment shown in FIGS. 1-4 illustrates a stack of laminated transparent lenses that can be affixed to a face shield on a helmet, FIGS. 7-8 illustrate an embodiment where the stack of lenses are affixed to a windshield by wetting the bottom adhesive layer and mounting it directly on the windshield, FIG. 9 illustrates an embodiment where the stack of lenses is used as a graffiti stop (e.g., on a bus), FIG. 10 illustrates an embodiment where the stack of lenses is used on a produce display and FIG. 11 illustrates an embodiment where the stack of lenses is used on a hand-held (e.g., palm) computing device.

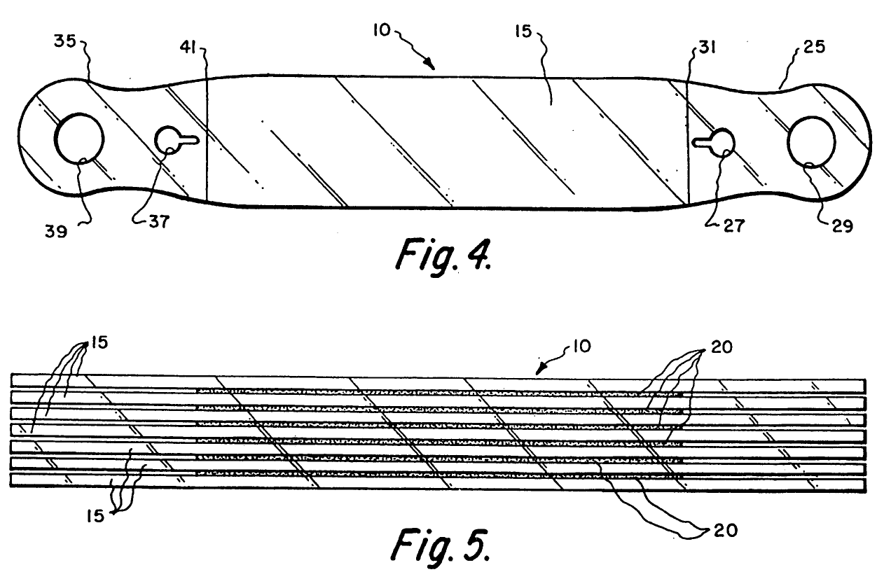

In the first embodiment shown and described, a stack of laminated transparent lenses is affixed to a face shield of a helmet. FIG. 4 is a front elevational view illustrating the present invention 10 before it is affixed to the face shield of the helmet. The top view in FIG. 5 illustrates adhesive layer 20, which includes seven layers of lenses 15 adhesively affixed to each successive lens.

The material used to form the lenses is preferably a clear polyester. The lens layers are fabricated from sheets of plastic film sold under the registered trademark Mylar owned by the DuPont Company. The several trademark registrations for the mark Mylar list several types of products sold under that mark, and include polyester film. The type of Mylar used in the present invention is made from the clear polymer polyethylene terephalate, commonly referred to as PET, which is the most important polyester. PET is thermoplastic—that is, it softens and melts at high temperatures. Uses of PET film include magnetic tapes and shrink wrap.

The adhesive 20 used to laminate the lenses together sequentially is a clear optical low tack material. The thickness of each lens ranges from 0.5 mil to 7 mil (1 mil is 0.001″). The preferred thickness is 2 mil. Even after the adhesive material is applied to a 2 mil thickness lens, the thickness of the 2 mil thickness lens will still be 2 mil because the adhesive has nominal thickness. As illustrated in FIG. 5, after the seven layers of film and the six layers of adhesive are laminated together, the overall thickness of the end product is 15 mils.

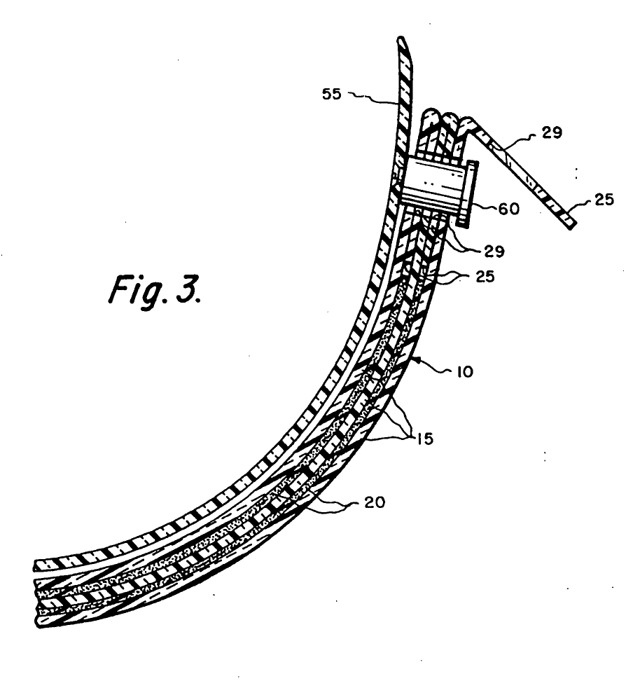

The term “wetting” can be used to describe the relationship between the laminated film layers. When viewing through the laminated layers, it appears to be one single piece of plastic film. Less than 2% reflections from the inner layers are evident. The end tab portions without the adhesive exhibit reflections, but do not affect the visibility of the user because these end portions are out of the field of view and folded back over the posts as illustrated in FIG. 3.

The adhesive material 20 is a water-based acrylic optically clear adhesive or an oil based clear adhesive, with the water based adhesive being the preferred embodiment. After the seven layers are laminated or otherwise bonded together with the adhesive layers, the thickness of each adhesive layer is negligible even though the adhesive layers are illustrated in FIGS. 3 and 5 as distinct layers. FIG. 5 is a top view of the stackable lenses illustrating seven layers of lenses held together by an adhesive applied between each lens with the thicknesses of the layers of lenses and applied adhesive highly exaggerated to clearly show the relationship between the lenses and the adhesive and also to show the end portions that do not have any adhesive between each lens layer for forming the removable tab portions 25 at both ends of the present invention.

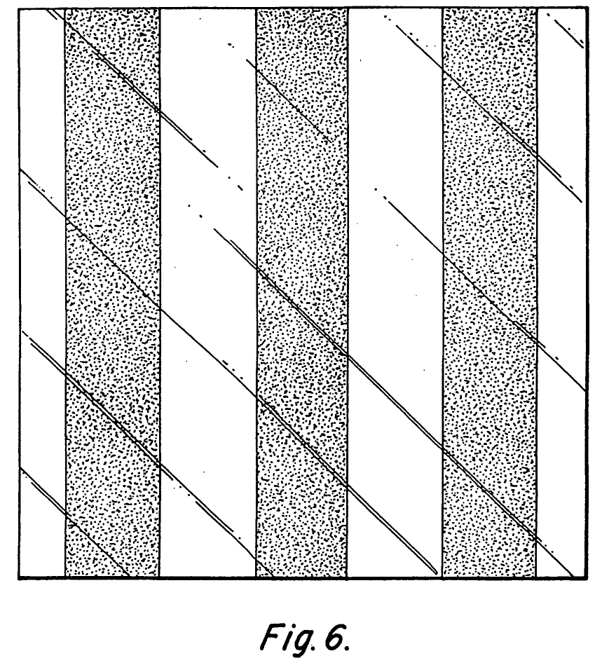

The individual stackable lens package, illustrated in FIG. 5 for use with racing helmets, can be fabricated from a roll of film as illustrated in FIG. 6. The film in FIG. 6 includes seven layers of clear polyester film and has the water-based acrylic adhesive laminating the seven film layers to one another. Keep in mind that each layer of the lenses can be easily peeled away as the top layer exposing the next clean lens. Each succeeding lens layer can be removed as the top lens becomes contaminated with dirt and grime during racing conditions.

Referring back now to FIG. 3. As previously stated, FIG. 3 illustrates the tension post 60 extending outwardly from the face shield 55 with the left side end tab portion 25 of the present invention illustrated. The face shield 55 has a left tension post 60 and a right tension post 65. Preferably, the present invention 10 has the following dimensions: 18″ in length; 2½″ in height; and about 15 mils in thickness. The present invention is symmetrical about its vertical medial axis and about its horizontal medial axis. The left end has a removable tab portion 25, and the right end has a removable tab portion 35. The area 15 indicates where the adhesive 20 is applied to the layers of the lens 15. The bilateral demarcation lines 31 and 41 indicate the locations of the adhesive stops on either side. The demarcation lines 31 and 41 also indicate where the tab portions begin. The present invention has a pair of bilateral keyhole-shaped slots 27 and 37 for demountably engaging the two helmet posts 60 and 65 respectively. The curved distance between the two helmet posts 60 and 65 is the same as the distance between the centers of the pair of slots 27 and 37. The user secures the lenses to the face shield by positioning the slots adjacent the helmet posts and passing the posts through the slots. It is preferable that the remainder of the tab portion outboard from the slot be folded back upon itself so that the finger hole is also passed through the helmet post as illustrated in FIG. 3. The proper installation of the present invention on the helmet requires the user to position the bottom lens of the stack through the post hole by passing the post through the slot, then folding back the remainder of the tab portion 25 so that the post passes through the finger hole 29. This is done for each lens working from the bottom up until the tab portion 25 of the top lens extends unfolded as illustrated in FIG. 2. In this manner, the helmet wearer can easily put his index finger through the finger hole of the topmost lens layer. The clean layer below the removed layer is then exposed and the removal tab portion on the exposed layer will spring back to the unfolded position to expose the finger hole so that the helmet wearer can easily remove that layer after it becomes soiled and contaminated. The plastic material forming the lenses is resilient and will spring back to its unfolded position and extend outwardly from the face shield. The thicknesses of the layered lenses and folded tab portions illustrated in FIG. 3 are highly exaggerated to clearly show the folding relationship. In actual practice seven lenses and seven tab portions are stacked into the space between the end of the post and the outer surface of the face shield. Remember that there is no adhesive between the tab portions. This allows the removal tab portions to fan out. They do not stick to one another.

The present invention as shown in the Figures has removal tab portions at both ends. This allows a right-handed or left-handed person to easily remove the topmost layer. It also allows the driver to pull the tab with either hand depending on the circumstances of the race. It is to be understood that the present invention may include a laminated lens with only a left tab portion 25, or only a right tab portion 35, or both a left and a right tab portion.

The windshield embodiment 100 illustrated in FIGS. 7 and 8 will now be discussed in detail. An optical stack of removable lenses for affixing to an optical window such as a racing car windshield is shown in FIG. 8. The embodiment 100 has a plurality of (e.g., seven) generally rectangular superposed removable lenses 105 adhesively affixed to one another. The outer perimeter is continuous. Each of the removable lenses 105 is held to each successive lens with a clear uninterrupted adhesive layer 110 interposed between each of the removable lenses. Preferably, but optionally, the perimeter has at least one generally straight edge portion 115. In the embodiment illustrated in FIG. 8, the perimeter is rectangular and has four straight edge portions, one for each side. It is to be understood that the invention could be practiced with only one generally straight edge portion, or even with no straight edges (e.g., circular or elliptical). The area adjacent to the straight edge portion 115 has a banded portion 120 that does not have any adhesive affixed to any of the layers of film to assist in allowing each said film layer 105 to be peeled off successively along the straight edge portion. A plurality of staggered tabs 125 are affixed to the film layers one at a time. The tabs 125 extend from the straight edge portions 120 to assist the user in removing the uppermost soiled and grimy film layer, and to successively remove each next clean layer as the top exposed layer becomes contaminated.

The adhesive layer can be foreshortened so as to expose successively a portion of the lens layers without optical wetting to create a grasping tab.

The stack of removable lenses as illustrated in FIGS. 7 and 8 can have an optically clear adhesive as the bottom last layer to aid in mounting the stack of lenses to the windshield. A temporary removable cover 107 may be adhered to the bottom layer of adhesive to protect the wetting adhesive 110 until installation. The stack is affixed to the windshield in much the same way that tinted window plastic film is affixed to a window. The windshield is sprayed with water and the bottom adhesive layer with the stack is then applied to the windshield. Air bubbles and the like are eliminated with a squeegee appliance. The bottom layer becomes “wetted” to the windshield.

The bottommost layer of film may be tinted, if desired. Such tinting is similar to the tinting of plastic window film. The tinting can be any one of a variety of colors, e.g., amber, gray, etc. The bottom layer may also include a metalized deposit to produce either a partial or total mirror effect.

The stack of removable lenses 100 can be applied to any type of optical window such as a windshield, a window, a face shield, or a video display. It is common at an ATM terminal to have a video display for the customer. The surface of the display can be kept clear by using the present invention.

The present invention may also be used as a graffiti stop to prevent damage to a surface caused by graffiti (e.g., a vehicle or a sign). For example, graffiti may be written on a vehicle body and/or vehicle windows. The graffiti may be applied, for example using paint or it may be scratched on, for example using a carbide tip or acid. It is very costly to repair property, such as a sign or a vehicle, after such vandalism. The stack of removable lenses 100 of the present invention can be used as a graffiti stop, for example on vehicles such as busses 90. As shown in FIG. 9, a stack of removable lenses (such as those shown in FIG. 7) can be applied to windows and/or the body of a vehicle, such as a bus 90.

The Mylar material used in the present invention is inert to acid. It also is scratch resistant, including scratching done with a carbide tip. Thus, the layers of lenses of the present invention 100 such as those shown in FIG. 7 can be adhered to a vehicle body and/or vehicle window. If graffiti is applied or etched into the surface, the affected layer is simply removed.

Preferably, the adhesive will cover the entire bottom surface of the bottom layer that is attached to the surface, e.g., the vehicle. Successive layers may have a portion, for example a strip, that does not have adhesive applied to the surface. The uppermost layer can easily be removed by grabbing the portion of the lens that does not have adhesive and removing the uppermost layer.

When the present invention is being used as a graffiti stop, the layers of lenses should not be apparent to the casual observer. Therefore, the layers should not include tabbed portions. Thus, the stack would resemble that of FIG. 7. Since the lenses are not apparent, a graffiti artist will not be tempted to remove the stack of optical lenses 100 prior to applying or etching graffiti on a surface, such as vehicle 90.

FIGS. 9A-9D illustrate removal of the top sheet of a stack of non-self evident layers of film. FIG. 9A illustrates a cross section of a stack of lenses 100 shown in FIG. 9. A tab 102, such as the one shown in FIG. 9D, can be affixed to the top sheet when removal of the top sheet is desired. The tab 102 includes an adhesive that is strong enough to adhere to the top layer. When the tab is pulled only the top layer of film is removed from the stack of film lenses 100 as shown in FIG. 9C.

The present invention has a multitude of uses where a clean surface is desired in a short period of time. As described above, uses include those where the surface is exposed to large amounts of dirt or debris in a short period of time, such as motorcycle or automobile racing, or instances where surfaces are purposely damaged by vandalism, such as graffiti. It will also be appreciated that the present invention can be used for more conventional uses where normal use causes above average dust or debris on a surface such that a system for providing a clean surface quickly and easily is desired. A couple of examples of other uses for the present invention are described next.

The present invention may also be used on merchandising displays. One such merchandizing display is a grocery display 110, for example, a produce display, such as the one shown in FIG. 10. Such displays typically include a reflective surface area 120 behind the produce so that there appears to be more produce on the display. The produce in-such display cases are frequently watered. Such frequent watering tends to spot the reflective surface. As shown in FIG. 10, the present invention 130 can be placed on the reflective surface 120. Thus, when the reflective surface becomes significantly water spotted, the top layer of the present invention 130 can be removed revealing a clean reflective surface.

The reflective surface shown in FIG. 10 can be obtained by placing clear layers over a display having a reflective surface. Alternatively, if the display does not have a reflective surface, a stack of layers with the bottommost layer having a reflective surface created by a metalized deposit can be used.

Another embodiment of the present invention is for use on computing displays. For example, the present invention may be used on hand held computing devices, such as personal digital assistants, as shown in FIG. 11. Use of protective film layers on display screens helps protect the screen from scratches, as well as reducing the glare on the screen. The stack of removable lenses 160 is placed on the display area 150 of the computing device 140. When the top lens becomes dirty, for example by having excessive fingerprints or scratches, the topmost layer can be removed. Preferably, the lenses do not include tabs. A removable tab such as that shown in FIG. 9D can be affixed to the top layer in order to remove it.

While it is recognized that an illustrative and preferred embodiment has been described herein, it is likewise to be understood that the inventive concepts may be otherwise embodied and employed and that the appended claims are intended to be construed to include such variations except insofar as limited by the prior art.

1. A stack of laminated removable lenses for affixing to a surface of an object consisting essentially of:
a plurality of superposed removable lenses adhesively affixed to one another;
each said removable lens being held to each successive lens with a clear uninterrupted adhesive layer interposed between each said removable lens.

2. The stack of laminated removable lenses as recited in claim 1 wherein the stack of removable lenses includes a bottom lens that is affixed to the surface of the object by wetting an adhesive layer on the bottom lens directly to the surface of the object.

3. The stack of laminated removable lenses as recited in claim 2 further comprising a temporary removable sheet cover temporarily affixed to the adhesive layer on the bottom lens to protect the adhesive layer on the bottom lens until the temporary removable sheet cover is removed so that the stack of removable lenses can be affixed to the surface of the object.

4. The stack of laminated removable lenses as recited in claim 1 wherein the removable lenses are generally rectangular.

5. The stack of laminated removable lenses as recited in claim 4 wherein the removable lenses form a continuous perimeter having a generally straight edge portion.

6. The stack of laminated removable lenses as recited in claim 5 wherein an area adjacent the straight edge portion has a banded portion that does not have any adhesive affixed to any of the layers of film to assist in allowing the film layer to be peeled off successively along the straight edge portion.

7. The stack of laminated removable lenses as recited in claim 1 wherein said removable lenses and said clear adhesive layers have an index of refraction between 1.40 and 1.52.

8. The stack of laminated removable lenses as recited in claim 1 wherein said removable lenses are made of a scratch resistant material.

9. The stack of laminated removable lenses as recited in claim 8 wherein said removable lenses are made of a material that is inert to acid.

10. The stack of laminated removable lenses as recited in claim 1 wherein said removable lenses are made of a Mylar material.

11. The stack of laminated removable lenses as recited in claim 1 wherein the surface of the object is a vehicle.

12. The stack of laminated removable lenses as recited in claim 11 wherein said stack of removable lenses is mounted to a window on the vehicle.

13. The stack of laminated removable lenses as recited in claim 11 wherein said stack of removable lenses is mounted on a body of the vehicle.

14. The stack of laminated removable lenses as recited in claim 1 wherein the surface of the object is a display screen.

15. The stack of laminated removable lenses as recited in claim 14 wherein the display screen is a display screen for a computing device.

16. The stack of laminated removable lenses as recited in claim 15, wherein the display screen is a display screen for a handheld computing device.

17. The stack of laminated removable lenses as recited in claim 1 wherein the surface of the object is a surface of a merchandising display.

18. The stack of laminated removable lenses as recited in claim 1 wherein the adhesive covers an entire surface of the removable lens that is affixed to the surface of the object.

19. The stack of laminated removable lenses as recited in claim 1 wherein a bottom lens of the stack is affixed to the surface of the object and the bottom lens is tinted.

20. The stack of laminated removable lenses as recited in claim 1 wherein a bottom lens of the stack is affixed to the surface of the object and the bottom lens is reflective.

21. The stack of laminated removable lenses as recited in claim 1 wherein the stack comprises a top lens and wherein a removable tab is used to remove the top lens from the stack of removable lenses.

22. The stack of laminated removable lenses recited in claim 1, wherein each of the lenses has a thickness of 0.5 mil. to 7 mil.

23. The stack of laminated removable lenses recited in claim 1, wherein each of the lenses has a thickness of about 2 mil.

24. The stack of laminated removable lenses recited in claim 1, wherein each said removable lens is held to each successive lens with the uninterrupted adhesive layer interposed between each said removable lens such that there are no evident reflections when looking through the stack of laminated removable lenses.

25. The stack of laminated removable lenses recited in claim 1, wherein each said removable lens is held to each successive lens with a clear uninterrupted adhesive layer of negligible thickness interposed between each said removable lens.

26. A stack of laminated removeable lenses for affixing to a surface of an object, the stack comprising:
a. a plurality of superposed removeable lenses adhesively affixed to one another;
b. an adhesive layer interposed between each successive lens, at least a portion of an edge of the top most lens having no adhesive; and
c. a tab adhereable to an environmental side of the portion of the top lens.

27. The stack of claim 26 wherein an adhesive between the top lens and the tab extends closer to the edge of the portion compared to the adhesive layer interposed between the top lens and its successive lens for peeling the, top lens off of the successive lens.

28. The stack of claim 26 wherein the tab is flexible.

29. The stack of claim 26 wherein edges of the lenses extend to edges of the surface such that the lens edge is not visible to a person
